(19) United States
(12) Patent Application Publication
(10) Pub. No.: US 2025/0390233 A1
(43) Pub. Date: Dec. 25, 2025

(54) SUSTAINABLE ARTIFICIAL INTELLIGENCE (AI) DATA STORAGE

(71) Applicant: INTERNATIONAL BUSINESS MACHINES CORPORATION, ARMONK, NY (US)

(72) Inventors: John S. Werner, Fishkill, NY (US); Arkadiy O. Tsfasman, Wappingers Falls, NY (US); Ryan Thomas Rawlins, Poughkeepsie, NY (US); Christopher V. DeRobertis, Hopewell Junction, NY (US); Andrew C. M. Hicks, Highland, NY (US); Pasquale A. Catalano, Wallkill, NY (US)

(21) Appl. No.: 18/747,803

(22) Filed: Jun. 19, 2024

(51) Int. Cl. G06F 3/06; G06F 16/35

(52) U.S. Cl. CPC G06F 3/0625; G06F 3/0638; G06F 3/068; G06F 16/355

(57) ABSTRACT

A method, computer system, and a computer program product for sustainable data storage is provided. A sustainable storage program receives raw data comprising data access statistics and power consumption of data currently in storage tiers. The received data is tagged by a usage model based on data context. The tagged data is vectorized, whereby the vectorizing includes clustering data types, and identifying a storage tier for each data type. The vectorized and tagged data is stored in a vector database. Incoming data is assigned to a storage tier based on a similarity search of the vector database, whereby the similarity measures the proximity or distance of two vectors in the vector database. The usage model and the vector database are continuously updated and monitored.

### BACKGROUND

The present invention relates generally to the field of computing, and more particularly to data storage technology.

Data moves to different storage tiers based on when it was last accessed. Therefore, although data will eventually move to deeper tiers of storage, until then it may be consuming more power than is required for current computational needs.

It would be advantageous from a sustainability perspective to store data in the correct tier as quickly as possible such that the overall tiered storage infrastructure draws the minimal amount of power across all systems.

### SUMMARY

Embodiments of the present invention disclose a method, computer system, and a computer program product for sustainable data storage. A sustainable storage program receives raw data comprising data access statistics and power consumption of data currently in storage tiers. The received data is tagged by a usage model based on data context. The tagged data is vectorized, whereby the vectorizing includes clustering data types, and identifying a storage tier for each data type. The vectorized and tagged data is stored in a vector database. Incoming data is assigned to a storage tier based on a similarity search of the vector database, whereby the similarity measures the proximity or distance of two vectors in the vector database. The usage model and the vector database are continuously updated and monitored.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is an operational flowchart illustrating a data storage tier monitoring; and

FIG. 3 is an operational flowchart illustrating tier prediction on a write command.

### DETAILED DESCRIPTION

A method, computer program product and system are provided for sustainable tiered data storage. As such, the present embodiment has the capacity to improve the technical field of data storage by storing data in the correct tier as quickly as possible such that the overall tiered storage infrastructure consumes the minimal amount of power across all systems.

Tiered storage is a method for assigning different categories of data to various types of storage media to reduce overall storage costs and improve the performance and availability of mission-critical applications. The tiered storage architecture is implemented using business defined rules that categorize data hierarchically based on various factors. For a data security requirement, for example, disks can be grouped by security classes, where one storage group is in an ultra-secure room but another that needs only simple encryption is in a less secure location. As another example, for performance tiering, storage media can be grouped by I/O speed. This rule ensures that the most frequently accessed information is on the fastest storage media. Additionally, a reliability requirement can define that storage pool metadata is isolated from user data. This may increase the reliability of the system because storing data and its defining metadata on the same device(s) presents a potential single point of failure.

Generally, the most important, and consequently the most frequently accessed, data is served from the fastest storage media (e.g., Non-Volatile Memory Express (NVMe), solid state disk drive (SSD)), which tends typically to be the most expensive storage media both in technology features and power consumption, at least because the devices experience the highest utilization. Less critical data may be written to a second tier including slower storage media, such as hard disk drives (HDD). A third tier might then be used for archiving data that needs to be kept indefinitely, with the data stored on tape drives or cloud storage platforms.

Generally, the lower the storage tier, the slower the data accessibility. Systems lower in storage tier also consume less power at least because they are not being accessed as frequently as the higher storage tiers. Consequently, it is an advantage from a sustainability perspective to store data in the correct storage tier as quickly as possible such that the overall tiered storage infrastructure draws the minimal amount of power across all systems.

Embodiments of the present invention monitor general data access and utilization to create an initial usage dataset that will be used to train a model. The utilization data comes from data currently in storage over a predetermined initial time frame (e.g., 6 months, 1 year, etc.), and includes what type of data resides in which tier of storage. This initial dataset can be collected using existing methods, such as the performance measurement utilities provided in the operating system, or any third-party performance monitors.

In either a manual or software-aided effort, the raw data in the dataset is labeled with one or more tags that give context about the data to the machine learning model. The data is tagged according to labels that are meaningful in the context of the data, including the program/application that was origin of the data, a transaction type, level of sensitivity if any of the data, the presence of personal information (if any), physical geographic location of the data, and any encryption requirements. The tagging/labeling can be performed manually, or by using supervised, semi-supervised, or unsupervised learning.

The tagged data is input to a neural network, with the result of the training being an embedding model. The embedding model can subsequently be used to transform the initial (and any future) raw data into vector embeddings. Therefore, the embedding model can predict where to place new data points in the vector space. The vector embedding is inserted into a vector database, which is a specialized type of database that stores data as high-dimensional vectors. The vectors are mathematical representations of features or attributes of the original tagged data.

In some embodiments, clustering techniques may be used to group (cluster) data types based on the multidimensional tags. A storage tier can then be identified for each cluster. To perform similarity search and retrieval in a vector database, a query vector represents the search criteria, such as similarity of vectorized data to be written to a storage device to an existing closest vector, and therefore, best tier for the data storage. A similarity measure calculates how close or distant two vectors in the vector space. The similarity measure can be based on various metrics, such as cosine similarity, Euclidean distance, or similar measures.

The result of the similarity search and retrieval may be a ranked list of vectors that have the highest similarity scores with the query vector. The corresponding raw data associated with each vector can be accessed from the original source or index.

The model may be continuously updated and monitored depending on model type employed (e.g., clustering). Incoming/new data can be tagged to identify a cluster within the model that it belongs to based on its distance to each existing cluster (e.g., using Euclidean distance, cosine similarity, etc.).

Once a cluster is assigned, the data can be assigned to the storage tier associated with the cluster, i.e., the data may be stored directly where similar data is stored, based on historical access history, thereby skipping levels of storage. This is distinct from the typical behavior of tiered storage systems, where incoming data is assigned to a default initial location. Actual tiering movement can occur over time as an access history is established. A data cluster may automatically move tiers based on access statistics and user or system defined thresholds/watermarks, such as number of I/O operations per second, or duration the data has been stored in the tier. For example, if a maximum access threshold (number of data requests) is achieved for data within a given tier within a threshold period of time, the entire cluster may move up a storage tier. Conversely, if an minimum access threshold (number of data requests) is not achieved for data within a given tier within a threshold period of time, the entire cluster may move down a storage tier.

In some embodiments, users may have the option to define and assign a custom tag to one or more data types or clusters, for example, an “eco” tag. Enabling this setting allows users to store some or all data in a way that will save power consumption at the cost of data latency or increased computational time. For example, data may be stored one tier lower than what may be considered as the optimal tier associated with the identified cluster.

According to an aspect of the invention, there is provided a computer-implemented method. A sustainable storage program receives raw data comprising data access statistics and power consumption of data currently in storage tiers. The received data is tagged by a usage model based on data context. The tagged data is vectorized, whereby the vectorizing includes clustering data types, and identifying a storage tier for each data type. The vectorized and tagged data is stored in a vector database. Incoming data is assigned to a storage tier based on a similarity search of the vector database, whereby the similarity measures the proximity or distance of two vectors in the vector database. The usage model and the vector database are continuously updated and monitored. This aspect may advantageously, from a sustainability perspective, store data in the correct tier as quickly as possible such that the overall tiered storage infrastructure draws the minimal amount of power across all systems.

According to another aspect of the invention, there is provided a computer-implemented method to define a data context, which includes: origin of the data, transaction type, level of sensitivity, encryption requirements. This aspect may advantageously characterize data for storage more efficiently.

According to another aspect of the invention, there is provided a computer-implemented method to optionally define a custom tag on one or more data types or data clusters to cause storage in at least one tier lower than the sustainable storage program determines. This aspect may advantageously store data in a tier to reduce the power consumption in the system.

According to another aspect of the invention, there is provided a computer-implemented method to tag new data and identify a cluster to which it belongs within a model based on a distance to each existing cluster. This aspect may advantageously characterize data access usage more accurately.

According to another aspect of the invention, there is provided a computer-implemented method whereby an entire data cluster moves tiers up or down in response to access statistics and configurable thresholds. This aspect may advantageously reduce data access operations by moving entire clusters at once.

According to another aspect of the invention, there is provided a computer-implemented method whereby a data type is tagged using supervised, semi-supervised, or unsupervised learning. This aspect may advantageously increase accuracy and speed of data characterization.

According to another aspect of the invention, there is provided a computer-implemented method to receive, by a channel subsystem, a command to write data. The sustainable storage program causes the channel subsystem to vectorize the data to write. The sustainable storage program causes the channel subsystem to locate a closest vector in the vector database. The sustainable storage program causes the channel subsystem to determine a storage classification tier. The data to write is stored at the determined storage classification tier. The vector database is updated. This aspect may advantageously improve the accuracy of the channel subsystem in storing data.

According to an aspect of the invention, there is provided a computer system. A sustainable storage program receives raw data comprising data access statistics and power consumption of data currently in storage tiers. The received data is tagged by a usage model based on data context. The tagged data is vectorized, whereby the vectorizing includes clustering data types, and identifying a storage tier for each data type. The vectorized and tagged data is stored in a vector database. Incoming data is assigned to a storage tier based on a similarity search of the vector database, whereby the similarity measures the proximity or distance of two vectors in the vector database. The usage model and the vector database are continuously updated and monitored. This aspect may advantageously, from a sustainability perspective, store data in the correct tier as quickly as possible such that the overall tiered storage infrastructure draws the minimal amount of power across all systems.

According to an aspect of the invention, there is provided a computer program product. A sustainable storage program receives raw data comprising data access statistics and power consumption of data currently in storage tiers. The received data is tagged by a usage model based on data context. The tagged data is vectorized, whereby the vectorizing includes clustering data types, and identifying a storage tier for each data type. The vectorized and tagged data is stored in a vector database. Incoming data is assigned to a storage tier based on a similarity search of the vector database, whereby the similarity measures the proximity or distance of two vectors in the vector database. The usage model and the vector database are continuously updated and monitored. This aspect may advantageously, from a sustainability perspective, store data in the correct tier as quickly as possible such that the overall tiered storage infrastructure draws the minimal amount of power across all systems.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

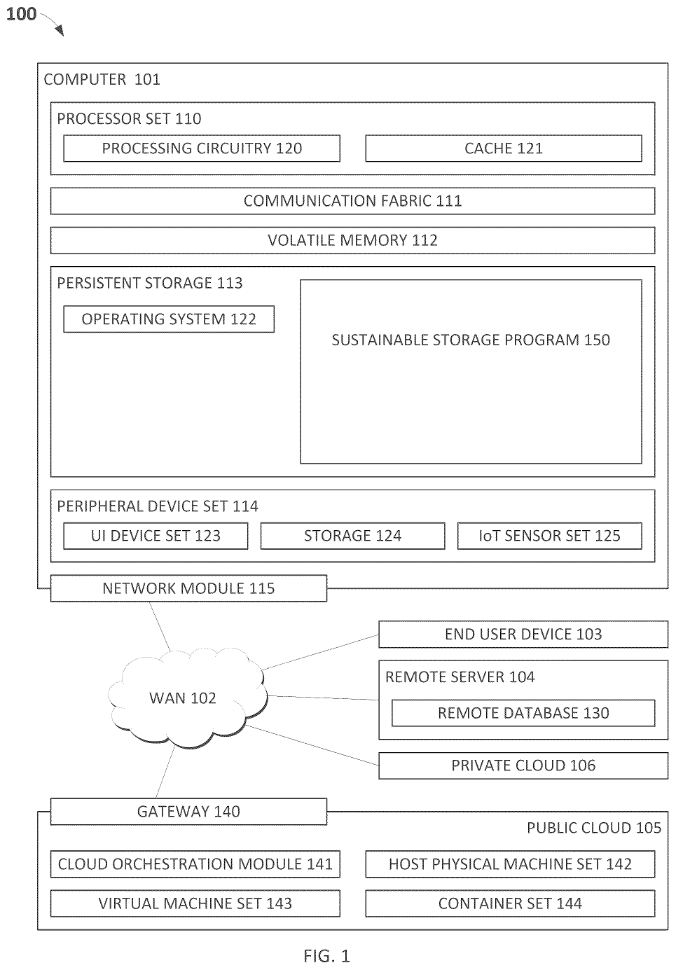

Referring to FIG. 1, a computing environment 100 according to at least one embodiment is depicted. Computing environment 100 contains an example of an environment for the execution of at least some of the computer code involved in performing the inventive methods, such as sustainable storage program 150. In addition to sustainable storage program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and sustainable storage program 150), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, sustainable storage program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The sustainable storage program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

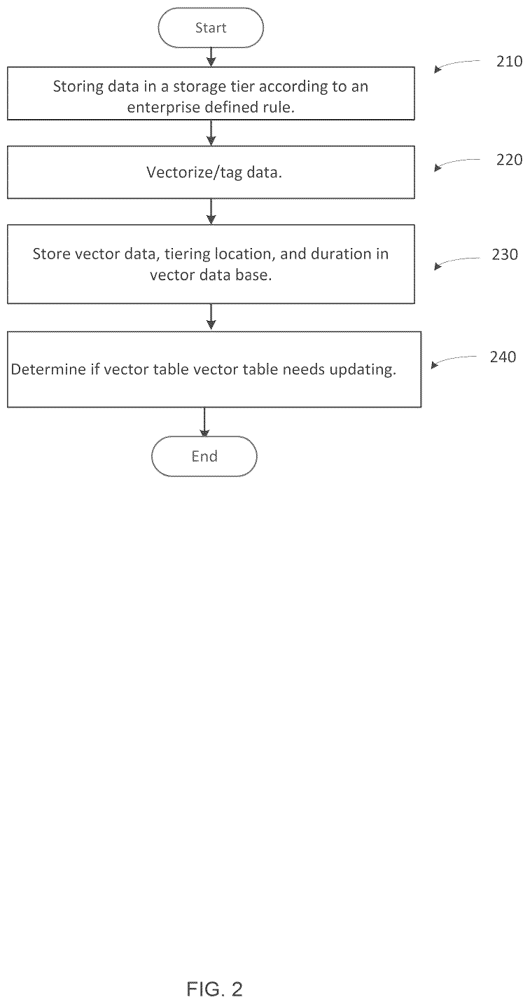

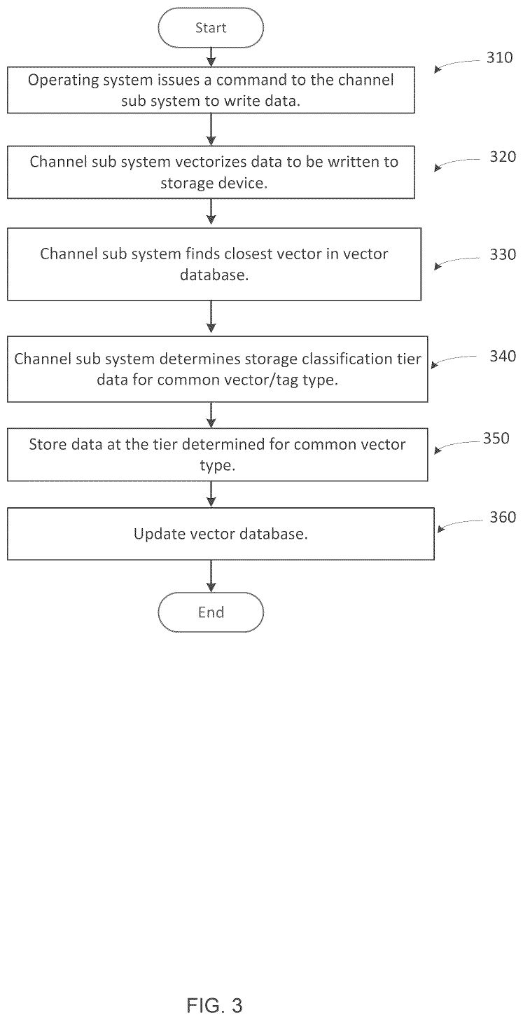

According to the present embodiment, a user using any combination of an EUD 103, remote server 104, public cloud 105, and private cloud 106 may use the sustainable storage program 150 to generate a custom remark prediction model (e.g., a machine learning model) for each user/meeting participant, to predict and block objectionable remarks from the meeting participant before the objectionable remarks are delivered to the other meeting participants. Embodiments of the present disclosure are explained in more detail below with respect to FIGS. 2-3.

It may be appreciated that FIGS. 2-3 provide only an illustration of one embodiment and do not imply any limitations with regard to how different embodiments may be implemented. Many modifications to the depicted embodiment(s) may be made based on design and implementation requirements.

FIG. 2 is an operational flowchart illustrating data storage tier monitoring.

Data is stored in a storage tier, according to an enterprise-defined tiering rule (210). In environments where the embodiments of the present invention are not implemented, the rule can be based at least on type of storage required (e.g., tape or disk) and an age threshold requirement for moving data to a different storage tier. Following implementation of the present invention, the sustainable storage program 150, makes storage tiering decisions based on observed behaviors and settings over time, as implemented in a trained usage model. A system administrator may retain the ability to fine-tune settings as needed.

The sustainable storage program 150 vectorizes (tags) the data according to one or more criteria, such as data size, data source, data destination, data location (tape, NVMe, SSD, and a storage classification tier. Tags are metadata (descriptors) that describe other factors the sustainable storage program 150 uses to determine to which tier of storage a given set of data best belongs. A vector is the set of tags that describe a given set of data. The tags adjust over time and may be added or removed based on changes in the system environment. For example, in a financial system, heavier system usage around end of year processing may cause a set of data to be escalated from a lower tier to a higher tier to reduce latency and meet the newer demand for the data. The sustainable storage program 150 tracks the assigned storage tier and how long the data remained at the tier. The sustainable storage program 150 uses this temporal information to determine if the currently assigned tier is the correct fit for the given set of data. For example, if a set of data was assigned to a lower tier, but is frequently accessed, the system may decide to raise the tier to reduce access latency (220).

The metadata associated with the data is stored in a table in the vector data base. The vector database may be a database that is specialized for the storage and retrieval of vector data, but is not so limited. The table may include a variety of storage structures, such as Virtual Storage Access Method (VSAM), virtual structure in memory, or hierarchical database. Based on the vector, the sustainable storage program 150 stores the tiering location in the vector database along with the duration the data was stored in the storage tier classification (230).

The sustainable storage program 150 assesses the initial storage classification in comparison with the actual storage location tiers on storage to determine if the vector table needs updating. This is a comparison between the tag vectors at initial data placement and the tag vectors sometime later. This comparison occurs at the end of a configurable time window, during which the data may have migrated over time, and indicates how accurate the sustainable storage program 150 was in modeling. The results of the comparison become input to update the trained usage model (240).

FIG. 3 is an operational flowchart illustrating tier prediction on a write command.

The operating system issues a command to the channel sub system to write data (310). The channel sub system through the sustainable storage program 150 vectorizes the data to be written to storage. The sustainable storage program 150 generates and appends the tags that describe the current set of data. In another embodiment, a systems administrator may manually add or modify the tags (320).

The channel sub system finds the closest vector in the vector database using the trained usage model. When new data is received to process, the sustainable storage program 150 calculates the distance of the current input data to each of the respective classifiers. The classifier with the smallest distance is the one the used to label/describe the new data. There are many algorithms to generate the classifiers (neural networks, K-means clustering, etc.) and some implementations allow for dynamic classifiers (online learning) where each input causes the classifiers to be updated. Others are trained separately where the model remains static until the next time it is specifically trained again (330).

The channel sub system through the sustainable storage program 150 determines the storage classification tier data for common vector/tag type. This is the output of the trained usage model analysis. Once the best classification is calculated, the sustainable storage program 150 labels the input data using the tags calculated to be the best fit (340). The data is routed to the tier corresponding to that type (350).

The vector data base is updated with new vector and tiering classification for that data, if a tier movement takes place (360).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving by a sustainable storage program raw data comprising data access statistics and power consumption of data currently in storage tiers;
tagging the received data by a usage model based on data context;
vectorizing the tagged data, wherein the vectorizing includes clustering data types, and identifying a storage tier for each data type;
storing the vectorized tagged data in a vector database;
assigning incoming data to a storage tier based on a similarity search of the vector database, wherein the similarity measures the proximity or distance of two vectors in the vector database; and
continuously updating and monitoring the usage model and vector database, based on the received raw data.

2. The computer-implemented method of claim 1, wherein the data context includes:
origin of the data;
transaction type;
level of sensitivity;
encryption requirements.

3. The computer-implemented method of claim 1, wherein an optionally defined custom tag is set on one or more data types or data clusters to cause storage in at least one tier lower than the sustainable storage program determines.

4. The computer-implemented method of claim 1, wherein new data is tagged to identify a cluster to which it belongs within a model based on a distance to each existing cluster.

5. The computer-implemented method of claim 1, wherein an entire data cluster automatically moves tiers up or down in response to access statistics and configurable thresholds.

6. The computer-implemented method of claim 1, wherein a data type is tagged using supervised, semi-supervised, or unsupervised learning.

7. The computer-implemented method of claim 1, further comprising:
receiving, by a channel subsystem, a command to write data;
the sustainable storage program causing the channel subsystem to vectorize the data to write;
the sustainable storage program causing the channel subsystem to locate a closest vector in the vector database;
the sustainable storage program causing the channel subsystem to determine a storage classification tier;
storing the data to write at the determined storage classification tier; and
updating the vector database.

8. A computer system, the computer system comprising:
one or more processors, one or more computer-readable memories, one or more computer-readable storage media, a set of computer program instructions stored in the one or more computer-readable memories and executed by at least one of the processors to perform actions of:
receiving by a sustainable storage program raw data comprising data access statistics and power consumption of data currently in storage tiers;
tagging the received data by a usage model based on data context;
vectorizing the tagged data, wherein the vectorizing includes clustering data types, and identifying a storage tier for each data type;
storing the vectorized tagged data in a vector database;
assigning incoming data to a storage tier based on a similarity search of the vector database, wherein the similarity measures the proximity or distance of two vectors in the vector database; and
continuously updating and monitoring the usage model and vector database, based on the received raw data.

9. The computer system of claim 8, wherein the data context includes:
origin of the data;
transaction type;
level of sensitivity;
encryption requirements.

10. The computer system of claim 8, wherein an optionally defined custom tag is set on one or more data types or data clusters to cause storage in at least one tier lower than the sustainable storage program determines.

11. The computer system of claim 8, wherein new data is tagged to identify a cluster to which it belongs within a model based on a distance to each existing cluster.

12. The computer system of claim 8, wherein an entire data cluster automatically moves tiers up or down in response to access statistics and configurable thresholds.

13. The computer system of claim 8, wherein a data type is tagged using supervised, semi-supervised, or unsupervised learning.

14. The computer system of claim 8, further comprising:
receiving, by a channel subsystem, a command to write data;
the sustainable storage program causing the channel subsystem to vectorize the data to write;
the sustainable storage program causing the channel subsystem to locate a closest vector in the vector database;
the sustainable storage program causing the channel subsystem to determine a storage classification tier;
storing the data to write at the determined storage classification tier; and
updating the vector database.

15. A computer program product, the computer program product comprising a non-transitory tangible storage device having program code embodied therewith, the program code executable by a processor of a computer to perform a method, the method comprising:
receiving by a sustainable storage program raw data comprising data access statistics and power consumption of data currently in storage tiers;
tagging the received data by a usage model based on data context;
vectorizing the tagged data, wherein the vectorizing includes clustering data types, and identifying a storage tier for each data type;
storing the vectorized tagged data in a vector database;
assigning incoming data to a storage tier based on a similarity search of the vector database, wherein the similarity measures the proximity or distance of two vectors in the vector database; and
continuously updating and monitoring the usage model and vector database, based on the received raw data.

16. The computer program product of claim 15, wherein the data context includes:
origin of the data;
transaction type;
level of sensitivity;
encryption requirements.

17. The computer program product of claim 15, wherein an optionally defined custom tag is set on one or more data types or data clusters to cause storage in at least one tier lower than the sustainable storage program determines.

18. The computer program product of claim 15, wherein new data is tagged to identify a cluster to which it belongs within a model based on a distance to each existing cluster.

19. The computer program product of claim 15, wherein an entire data cluster automatically moves tiers up or down in response to access statistics and configurable thresholds.

20. The computer program product of claim 15, further comprising:
receiving, by a channel subsystem, a command to write data;
the sustainable storage program causing the channel subsystem to vectorize the data to write;
the sustainable storage program causing the channel subsystem to locate a closest vector in the vector database;
the sustainable storage program causing the channel subsystem to determine a storage classification tier;
storing the data to write at the determined storage classification tier; and
updating the vector database.
